(19) United States
(12) Patent Application Publication
(10) Pub. No.: US 2005/0087102 A1
(43) Pub. Date: Apr. 28, 2005

(54) Encapsulated nanoparticles for the absorption of electromagnetic energy in ultraviolet range

(75) Inventors: Manfred R. Kuehnle, Lincoln, MA (US); Hermann Statz, Wayland, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Manfred R. Kuehnle, Lincoln, MA (US)

(21) Appl. No.: 10/780,896

(22) Filed: Feb. 18, 2004

Related U.S. Application Data
(60) Provisional application No. 60/449,887, filed on Feb. 25, 2003.
(60) Provisional application No. 60/450,131, filed on Feb. 25, 2003.

(51) Int. Cl. C03C 14/00; B32B 5/16; C09C 3/10

(52) U.S. Cl. 106/31.65; 501/32; 428/403; 428/323; 106/31.72; 106/636; 106/241; 106/403; 106/404; 106/425; 106/436; 106/430; 106/500

(57) ABSTRACT

Composite materials that can be used to block ultraviolet radiation of a selected wavelength range are disclosed. The materials include dispersions of particles that exhibit optical resonance behavior, resulting in absorption cross-sections that substantially exceed the particles' geometric cross-sections. The particles are preferably manufactured as uniform nanosize encapsulated spheres, and dispersed evenly within a carrier material. Either the inner core or the outer shell of the particles comprises a conducting material exhibiting plasmon (Froehlich) resonance in a desired spectral band. The large absorption cross-sections ensure that a relatively small volume of particles will render the composite material fully opaque (or nearly so) to incident radiation of the resonance wavelength, blocking harmful radiation. The materials of the present invention can be used in manufacturing sunscreens, UV filters and blockers, ink, paints, lotions, gels, films, textiles, wound dressing and other solids having desired ultraviolet radiation-absorbing properties. The materials of the present invention can be used in systems consisting of reflecting substances such as paper or transparent support such as plastic or glass films. The particles can be further embedded in transparent plastic or glass beads to ensure a minimal distance between the particles.

### RELATED APPLICATION(S)

This application claims the benefit of U.S. Provisional Application No. 60/449,887, filed on Feb. 25, 2003, and is also related to U.S. Provisional Application 60/450,131, filed on Feb. 25, 2003. The entire teachings of the above application are incorporated herein by reference.

### BACKGROUND OF THE INVENTION

The present invention relates to the selective absorption of electromagnetic radiation by small particles, and more particularly to solid and liquid composite materials that absorb strongly within a chosen, predetermined portion of the electromagnetic spectrum, such as ultraviolet band, while remaining substantially transparent outside this region.

The effect of exposure to ultraviolet radiation of most organic and some inorganic substances can be damaging. To gain protection, sun shields, umbrellas, clothing, windows, lotions, and creams are used.

Protection of skin against ultraviolet radiation has, in the past, been achieved with sun lotions containing organic substances such as melanin, benzophenore, Patimate-O®, avobenzone, or inorganic compounds, such as zinc oxide or titanium dioxide. In many cases, while the sun lotion appears visually transparent, the deposit looks distinctly white.

Another type of UV-absorbing material is described in U.S. Pat. Nos. 5,534,056 and 5,527,386. This material features silicon nanoparticles particles that absorb UV radiation due to the phenomena of band-gap electron transitions as well as “entrapment” of the electromagnetic waves by total internal reflection. While rendering UV protection, silicon, unfortunately, also absorbs slightly in the blue region of the visual spectral band, thus causing a yellow tint on the deposition surface such as human skin.

Because sun lotions decompose in ultraviolet (UV) light, and/or wash off quickly in salt water, the need exists for new materials that are stable in UV light and transparent in the visible spectrum. It is also desirable to increase the degree of protection that the currently available compositions can offer.

### SUMMARY OF THE INVENTION

In a preferred embodiment the present invention is an ultraviolet radiation-absorbing material that comprises particles constructed of an outer shell and an inner core wherein either the core or the shell comprises a conductive material. The conductive material has a negative real part of the dielectric constant in a predetermined spectral band. Furthermore, either (i) the core comprises a first conductive material and the shell comprises a second conductive material different from the first conductive material; or (ii) either the core or the shell comprises a refracting material with a refraction index greater than about 1.8. In other embodiments, given a specific material, and for a fixed inner core diameter, selecting a specific shell thickness allows for shifting the peak resonance, and thus peak absorption, across the spectrum.

Sunscreens, UV blockers, filters, ink, paints, lotions, gels, films, textiles, wound dressings and other solids, which have desired ultraviolet radiation-absorbing properties, may be manufactured utilizing the aforementioned material.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a plot of the real parts of the dielectric constants of TiN, HfN, and ZrN as functions of wavelength.

FIG. 2 is a 3-dimensional plot that shows absorption cross-section of ZrN spheres as a function of both radius and wavelength.

FIG. 3 is a 3-dimensional plot that shows the absorption of a specified amount of TiN spheres as a function of both radius and wavelength.

FIG. 4 is a plot of absorption cross-section of TiN spheres in three different media with different refraction indices.

FIG. 5 is a plot of absorption (solid) and extinction (dash) cross-sections of spheres with titanium nitride cores and silver shells.

FIG. 6 is a plot of absorption (solid) and extinction (dash) cross-sections of spheres with ZrN cores and silver shells.

FIG. 7 is a plot of absorption (solid) and extinction (dash) cross-sections of spheres with ZrN cores and aluminum shells.

FIG. 8 is a plot of absorption (solid) and extinction (dash) cross-sections of spheres with aluminum cores and TiO₂ shells in the UV range.

FIG. 9 is a plot of light transmission as a function of wavelength through a coating containing spheres with Al cores and TiO₂ shells of variable thickness at the indicated load factor.

FIG. 10 is a plot of light transmission as a function of wavelength through a coating containing spheres with Al cores and TiO₂ shells of the indicated thickness for a range of load factors.

FIG. 11 is a plot of light transmission as a function of wavelength through a coating containing spheres with Al cores and Si shells of variable thickness at the indicated load factor.

FIG. 12 is a plot of absorption (solid) and extinction (dash) cross-sections of spheres with Al cores and aluminum oxide shells of variable thickness.

FIG. 13 is a plot of absorption (solid) and extinction (dash) cross-sections of spheres with Al cores and silver shells of variable thickness.

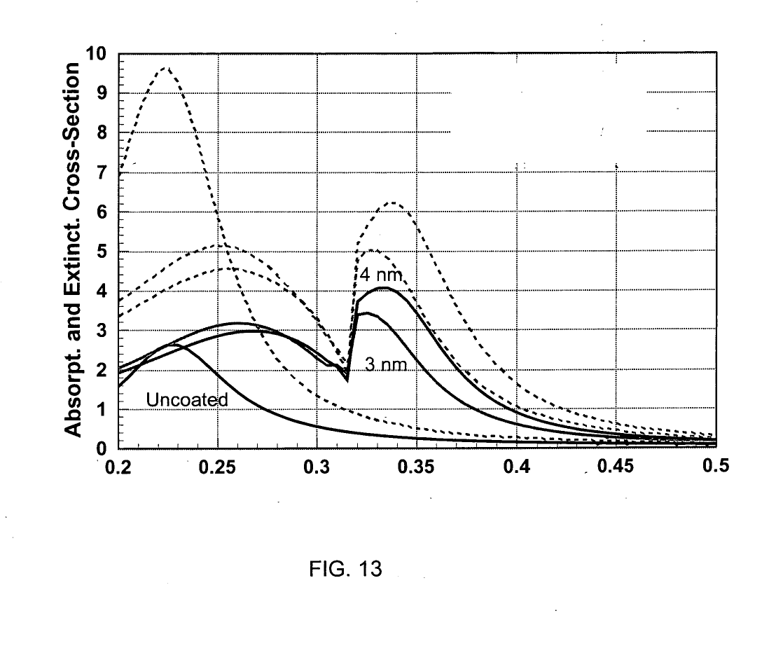

FIG. 14 is a schematic representation of the manufacturing process that can be used to produce the particles of the present invention.

FIG. 15 shows a detailed schematic diagram of the nanoparticles production system.

FIG. 16 depicts the steps of particle formation.

### DETAILED DESCRIPTION OF THE INVENTION

Prior to discussing the details of the preferred embodiments of the present invention, certain terms used herein are defined as follows:

An electrical conductor is a substance through which electrical current flows with small resistance. The electrons and other free charge carriers in a solid (e.g., a crystal) can to possess only certain allowed values of energy. These values form levels of energetic spectrum of a charge carrier. In a crystal, these levels form groups, known as bands. The electrons and other free charge carriers have energies, or occupy the energy levels, in several bands. When voltage is applied to a solid, charge carriers tend to accelerate and thus acquire higher energy. However, to actually increase its energy, a charge carrier, such as electron, must have a higher energy level available to it. In electrical conductors, such as metals, the uppermost band is only partially filled with electrons. This allows the electrons to acquire higher energy values by occupying higher levels of the uppermost band and, therefore, to move freely. Pure semiconductors have their uppermost band filled. Semiconductors become conductors through impurities, which remove some electrons from the full uppermost band or contribute some electrons to the first empty band. Examples of metals are silver, aluminum, and magnesium. Examples of semiconductors are Si, Ge, InSb, and GaAs.

A semiconductor is a substance in which an empty band is separated from a filled band by an energetic distance, known as a band gap. For comparison, in metals there is no band gap above occupied band. In a typical semiconductor the band gap does not exceed about 3.5 eV. In semiconductors the electrical conductivity can be controlled by orders of magnitude by adding very small amounts of impurities known as dopants. The choice of dopants controls the type of free charge carriers. The electrons of some dopants may be able to acquire thermal energy and transfer to an otherwise empty “conduction band” by using the levels of the uppermost band. Other dopants provide the necessary unoccupied energy levels, thus allowing the electrons of an otherwise full band to leave the band and reside in the so-called acceptor dopant. In such semiconductors, the free charge carriers are positively charged “holes” rather than negatively charged electrons. Semiconductor properties are displayed by the elements of Group IV as well as compounds that include elements of Groups III and V or II and VI. Examples are Si, AlP, and InSb.

A dielectric material is a substance that is a poor conductor of electricity and, therefore may serve as an electrical insulator. In a dielectric, the conduction band is completely empty and the band gap is large so that electrons cannot acquire higher energy levels. Therefore, there are few, if any, free charge carriers. In a typical dielectric, the conducting band is separated from the valence band by a gap of greater than about 4 eV. Examples include porcelain (ceramic), mica, glass, plastics, and the oxides of various metals, such as TiO₂. An important property of dielectrics is a sometimes relatively high value of dielectric constant.

A dielectric constant is the property of a material that determines the relative its electrical polarizability and also affects the velocity of light in that material. The wave propagation speed is roughly inversely proportional to the square root of the dielectric constant. A low dielectric constant will result in a high propagation speed and a high dielectric constant will result in a much slower propagation speed. (In some respects the dielectric constant is analogous to the viscosity of the water.) In general, the dielectric constant is a complex number, with the real part giving reflective surface properties, and the imaginary part giving the radio frequency absorption coefficient, a value that determines the depth of penetration of an electromagnetic wave into media.

Refraction is the bending of the normal to the wavefront of a propagating wave upon passing from one medium to another where the propagation velocity is different. Refraction is the reason that prisms separate white light into its constituent colors. This occurs because different colors (i.e., frequencies or wavelengths) of light travel at different speeds in the prism, resulting in a different amount of deflection of the wavefront for different colors. The amount of refraction can be characterized by a quantity known as the index of refraction. The index of refraction is directly proportional to the square root of the dielectric constant.

Total internal reflection. At an interface between two transparent media of different refractive index (glass and water), light coming from the side of higher refractive index is partly reflected and partly refracted. Above a certain critical angle of incidence, no light is refracted across the interface, and total internal reflection is observed.

Plasmon (Froehlich) Resonance. As used herein, plasmon (Froehlich) resonance is a phenomenon which occurs when light is incident on a surface of a conducting materials, such as the particles of the present invention. When resonance conditions are satisfied, the light intensity inside a particle is much greater than outside. Since electrical conductors, such as metals or metal nitrides, strongly absorb electromagnetic radiation, light waves at or near certain wavelengths are resonantly absorbed. This phenomenon is called plasmon resonance, because the absorption is due to the resonance energy transfer between electromagnetic waves and the plurality of free charge carriers, known as plasmon. The resonance conditions are influenced by the composition of a conducting material.

Introductory Information on Froehlich (Plasmon) Resonance.

The property which is of importance here is the fact that in many conductors, the real part of the dielectric constant is negative for ultraviolet and optical frequencies. The origin of this effect is known: free conduction electrons in a high frequency electric field exhibit an oscillatory motion. For unbound electrons, this electron motion is 180 degrees out of phase with the electric field. This phenomenon is well known in many resonators, even simple mechanical ones. A mechanical example is provided by the motion of a tennis ball attached by a weak rubber band to a hand moving rapidly back and forth. When the hand is in its maximum positive excursion on an imagined x-axis, the tennis ball would be at its maximum negative excursion on the same axis, and vise versa.

The weakly bound or unbound electrons in a high frequency electric field act basically in the same way. Electronic polarization, i.e. a measure of the responsiveness of electrons to external field, is therefore negative. Since in elementary electrostatics it is known that the polarization is proportional to ε−1, where ε is a so-called “dielectric constant” (actually, a function of wavelength, or frequency, of an external field), it follows that ε has to be smaller than one—it may in fact even be negative.

As mentioned above, the dielectric constant is a complex number, proportional to the index of refraction. In tables of optical constants of metals one finds usually tabulated the real and imaginary parts of the index of refraction, N and K, as a function of wavelength. The dielectric constant is the square of the index of refraction, or
εᵣₑₐₗ+jε_{imag}=(N+jK)=N²−K²+2jNK
or
εᵣₑₐₗ=N²−K²
ε_{imag}=2NK
and thus it may be seen that εᵣₑₐₗ is negative when K is larger than N. A look at the above-alluded tables of optical constants reveals that indeed this condition is frequently satisfied.

It is also possible to estimate electrical field inside a small dielectric sphere using an electrostatic approximation. Consider a case where the wavelength of the incident electromagnetic wave is much larger than the sphere radius. In this case, the sphere is surrounded by an electric field, which is approximately constant over the dimensions of the sphere. From elementary electrostatics we obtain the magnitude of the field inside of the sphere:

$${E}_{inside} = {E}_{outside} \frac{3 {ɛ}_{outside}}{2 {ɛ}_{outside} + {ɛ}_{inside}}$$

where E_{outside} is the surrounding field, E_{inside} is the field inside the sphere and ε_{inside} and ε_{outside} are the relative dielectric constants inside the sphere and in the surrounding medium, respectively. From the above equation it is apparent that the field inside the sphere would become infinitely large if the condition
2ε_{outside}+ε_{inside}=0
would be satisfied. Since the dielectric constants are not real, the field would become large but not infinite.

In case of an oscillating electric field that is a part of the light wave, that large field would of course also result in a correspondingly large absorption by the metal. This field enhancement is the cause of strong absorption peaks produced in metals nanospheres. Taking into account the complex dielectric constant, one can calculate the approximate absorption cross-section, provided that the imaginary part of the dielectric constant is small. Leaving out a few steps, one finds for for the cross-section Q_{abs}:

$${Q}_{abs} = 12 \times \frac{{ɛ}_{medium} {ɛ}_{imag}}{{( {ɛ}_{real} + 2 {ɛ}_{medium} )}^{2} + {ɛ}_{imag}^{2}}$$

In the above equation ε_{medium} is the dielectric constant of the medium, εᵣₑₐₗ and ε_{imag} are the real and imaginary parts of the dielectric constant of the metal sphere. The quantity x is given by
x=2πrN_{medium}/λ
where r is the sphere radius and λ is the wavelength. Again when that part of the denominator that is in brackets becomes zero, a maximum absorption is expected. For large values of absorption with a distinct and clearly delineated absorption region ε_{imag} should stay small. It can be seen that the maximum absorption wavelength shifts when the dielectric constant of the medium is changed. This is one of the ways of fine-tuning the absorption range for a given conductor.

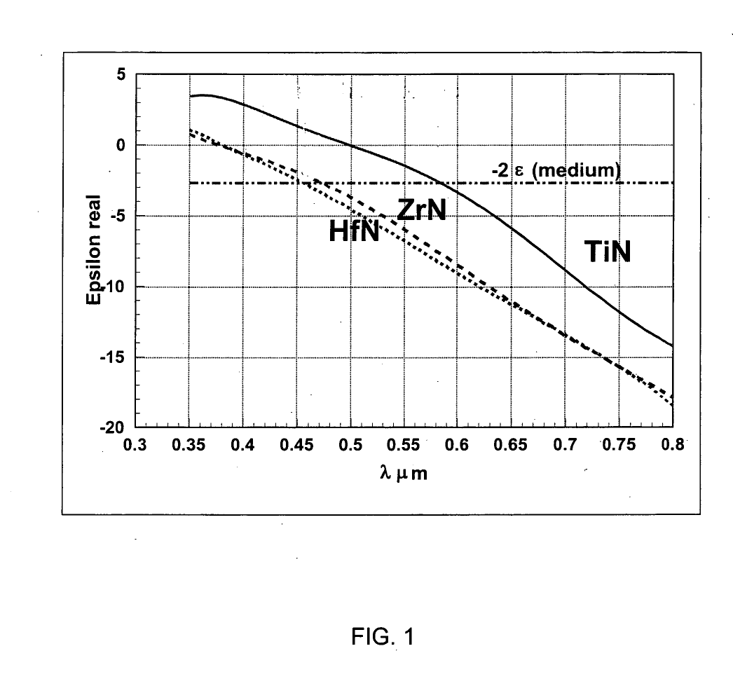

Since, for different materials, εᵣₑₐₗ are different functions, the resonant absorption due to plasmon effect occurs at different wavelengths, as shown in FIG. 1. FIG. 1 shows the real dielectric constant of three metallic Nitrides exhibiting a Froehlich Resonance. The Froehlich resonance frequency is determined by the position where the epsilon (real) curves intersect the line marked “−2 epsilon (medium)”.

The Shape and the Size of a Particle

The shape of the particle is important. The field inside an oblate particle, such as a disk, in relation to the field outside of that particle is very different from the field inside spherically shaped particle. If the disk lies perpendicular to the direction of the field lines then

$${E}_{inside} = \frac{{ɛ}_{outside}}{{ɛ}_{inside}} {E}_{outside}$$

Here the resonance with the large absorption would occur at such a wavelength, where ε_{inside}=0. If the disk were thin and aligned with the field, then E_{inside}=E_{outside} and no singularity and thus no resonance would occur at all. In general, the shape of the particle is preferably substantially spherical in order to prevent anisotropic absorption effects.

There is a small shift in wavelength of the absorption that comes from particle size. As the particle becomes larger the above simple assumptions break down. Without proof, increase in particle size shifts the absorption peak slightly towards the red, i.e. longer wavelengths. Larger particles also become less effective as absorbers because the material occupying the innermost portion of the sphere never sees the electromagnetic radiation that they might absorb because the outer layers have already absorbed the incident resonance radiation. For larger spheres the resonance character gradually vanishes. The absorption and extinction cross sections start to be less pronounced as the size of the sphere grows. Absorption and especially extinction shifts also more to the longer wavelengths.

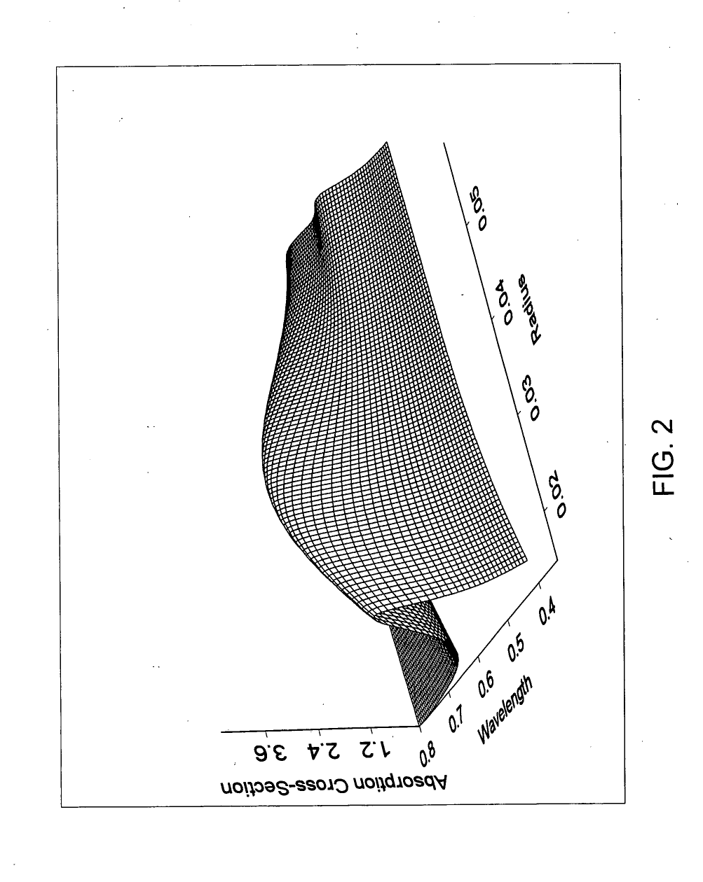

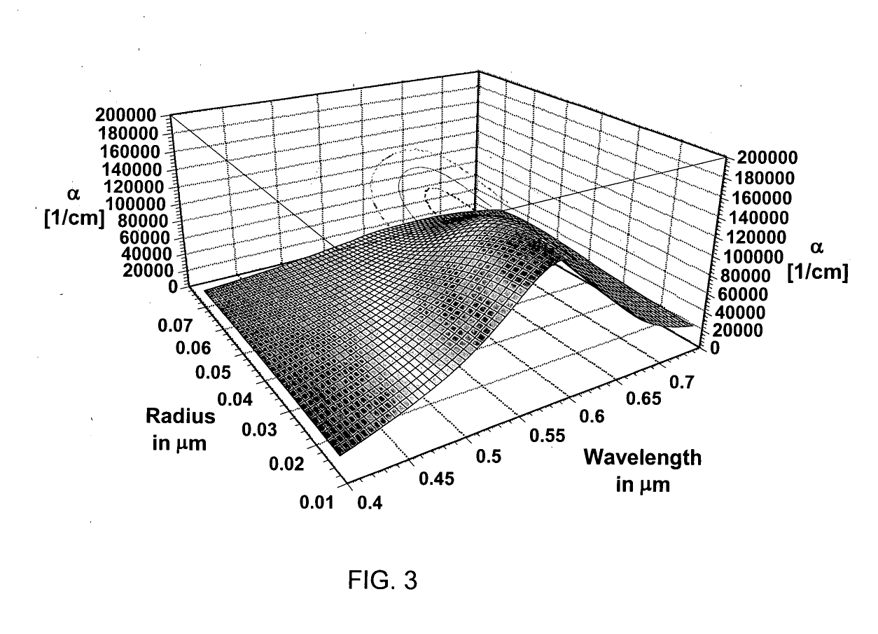

For further illustration of the behavior of the absorption cross-sections see the three-dimensional plot in FIG. 2, which shows a 3-dimensional plot of absorption cross-section of ZrN plotted against radius and wavelength. To actually determine optimal particle sizes, it is best to plot transmission, absorption and extinction. While the absorption cross-section decreases for small particles, there are many more small particles present per unit weight than big particles. Interestingly, it appears that small particles of a given total mass absorb just about as well as somewhat larger particles with the same total mass. Most importantly small particles do not scatter. These points are illustrated for TiN with FIG. 3 showing the absorption coefficient of 1 g of TiN spheres suspended in 1 cm³ of solution with an index of N=1.33. Small particles give the best absorption, and below a critical radius of about 0.025 micrometer it does not matter how small the particles are.

The Effect of the Media

There is also an absorption shift that depends upon the dielectric constant of the medium carrying the particles of the present invention. The Drude theory gives an approximate value for the real part of the dielectric constant that varies as

$${ɛ}_{real} = 1 - \frac{{v}_{plasma}^{2}}{{v}^{2}}$$

where vₚₗₐₛₘₐ is the so-called plasma frequency and v is the frequency of the light wave. The plasma frequency usually lies somewhere in the ultra violet portion of the spectrum. Gold spheres have an absorption peak near 5200 A. TiN, ZrN and HfN, which look golden colored, have a peaks at shorter and longer wavelengths as we shall show below. TiN colloids have been seen to exhibit blue colors due to green and red absorption.

The above described behavior of the dielectric constants allows us to estimate how much the absorption peak shifts when the dielectric constant of the medium is changed. Using a simple Taylor series expansion of the above expressions up to the first order, we obtain:

$$Δ λ = {λ}_{0} \frac{{Δɛ}_{medium}}{3}$$

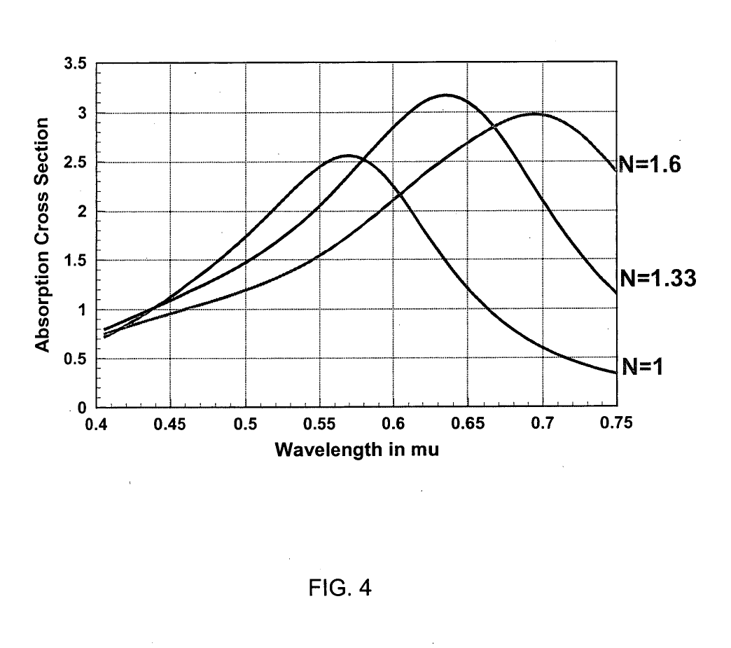

If the absorption maximum occurs at 6000 A, and we increase the dielectric constant of the medium by 0.25, then the absorption peak shifts up by 500 A to 6500 A. If we decrease the dielectric constant then the absorption shifts to shorter wavelengths. This point is illustrated in FIG. 4, which shows absorption cross-section for TiN spheres with a radius of 50 nm in media with three different indices of refraction: 1, 1.33, and 1.6.

### PREFERRED EMBODIMENTS OF THE INVENTION

The present invention relates to composite materials capable of selective absorption of electromagnetic radiation within a chosen, predetermined portion of the electromagnetic spectrum while remaining substantially transparent outside this region. More specifically, in the preferred embodiment, the instant invention provides small particles, said particles having an inner core and an outer shell, wherein the shell encapsulates the core, and wherein either the core or the shell comprises a conductive material. The conductive material preferably has a negative real part of the dielectric constant of the right magnitude in a predetermined spectral band. Furthermore, either (i) the core comprises a first conductive material and the shell comprises a second conductive material different from the first conductive material, or (ii) either the core or the shell comprises a refracting material with a large refraction index approximately greater than about 1.8.

For example, in one embodiment, the particle of the instant invention comprises a core, made of a conducting material, and a shell, comprising a high-refractive index material. In another embodiment, the particle comprises a core of high-refractive index material and a shell of conductive material. In yet another embodiment, the particle of the present invention comprises a core, composed of a first conducting material, and a shell comprising a second conducting material, with the second conductive material being different from the first conducting material.

In one preferred embodiment, the particle exhibits an absorption cross-section greater than unity in a predetermined spectral band. In another embodiment the particle is spherical or substantially spherical, having a diameter from about 1 nm to about 150 nm. The preferred shell thickness is from about 1 nm to about 20 nm.

Any material having a refractive index greater than about 1.8 and any material possessing a negative real part of the dielectric constant in a desirable spectral band may be used to practice the present invention. In the preferred embodiment these materials comprise Ag, Al, Mg, Cu, Ni, Cr, TiN, ZrN, HfN, Si, TiO₂, ZrO₂, Al₂O₃ and others.

The shift of the resonance absorption across a predetermined spectral band is achieved, in one embodiment, by varying the thickness of the shell, and in another embodiment, by varying the materials of the shell and/or the core. In yet another embodiment, both may be varied.

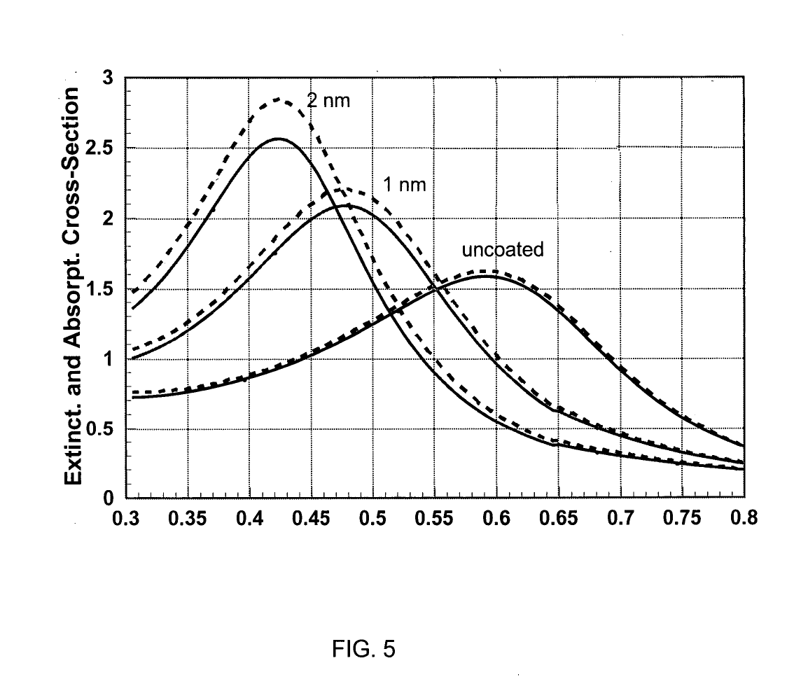

If two conducting materials are used, one in the core and the other in the shell, the particle will usually have resonance absorption at a wavelength that is between the peaks of each of the conducting materials. This makes it possible, by selecting the materials of the core and of the shell and/or by adjusting the ratio of the thickness of the shell to the diameter of the core, to shift the peak of absorption in either direction across both visible and UV bands. For example, while TiN has its resonance peak in the visible range, silver exhibits resonance absorption near the edge of the UV band. As illustrated in FIG. 5, which shows absorption (solid line) and extinction (dashed line) cross-sections for 20 nm-radius TiN spheres coated with either 1 m or 2 nm thick shell of silver, adjusting the thickness of the silver shell shifts the peak toward the shorter wavelengths.

In the figures described below, the solid lines represent absorption and the dashed lines represent extinction.

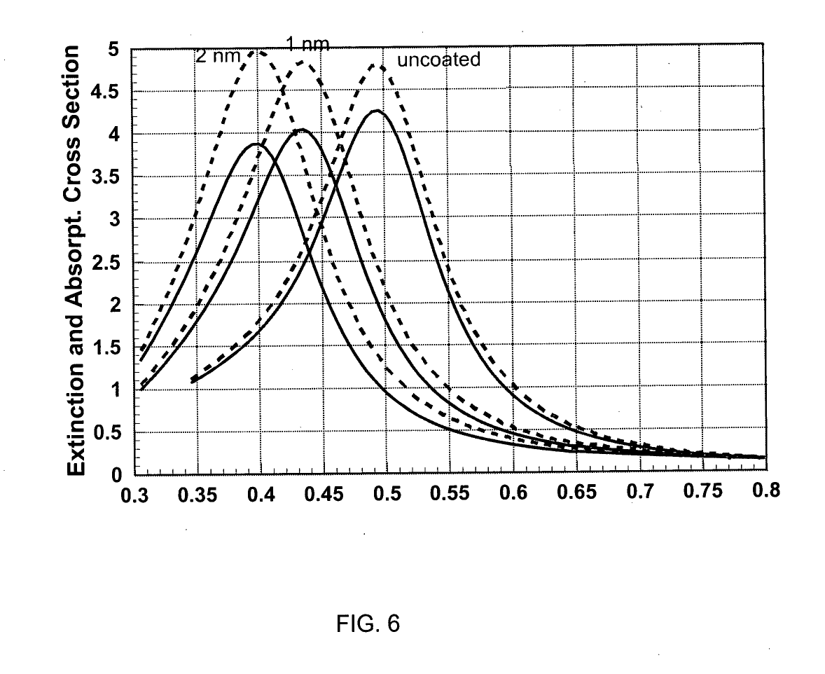

FIG. 6 shows that the resonant absorption peak of a ZrN core, radius 22 nm, coated with a silver shell, can be shifted depending on the thickness of the shell. The shift is toward the shorter wavelengths. Shells are 0 nm, 1 nm, and 2 nm thick.

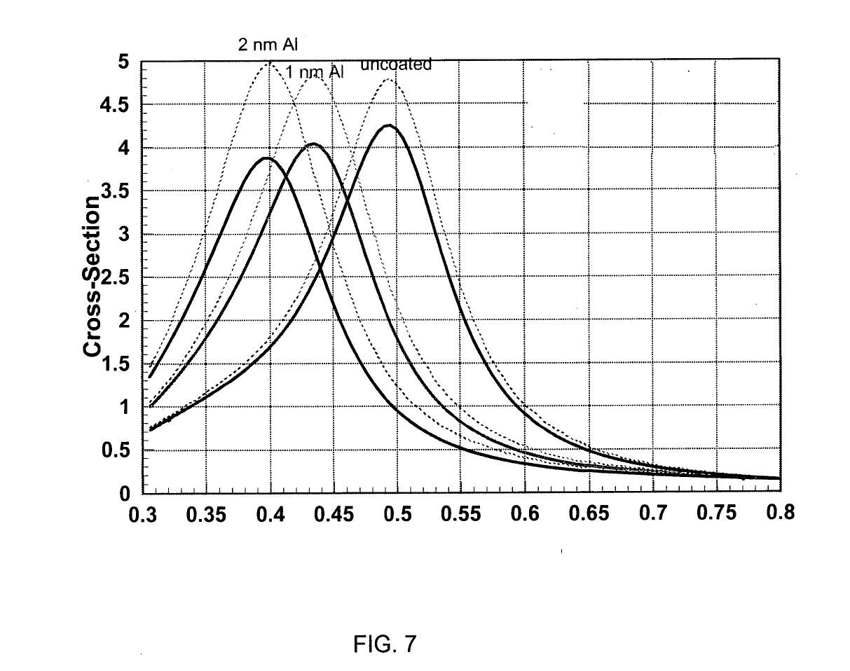

FIG. 7 shows that the resonant absorption peak of a ZrN core, radius 22 nm, coated with an aluminum shell, can be shifted depending on the thickness of the shell. The shift is toward the shorter wavelengths. Shells are 0 nm, 1 nm, and 2 nm thick.

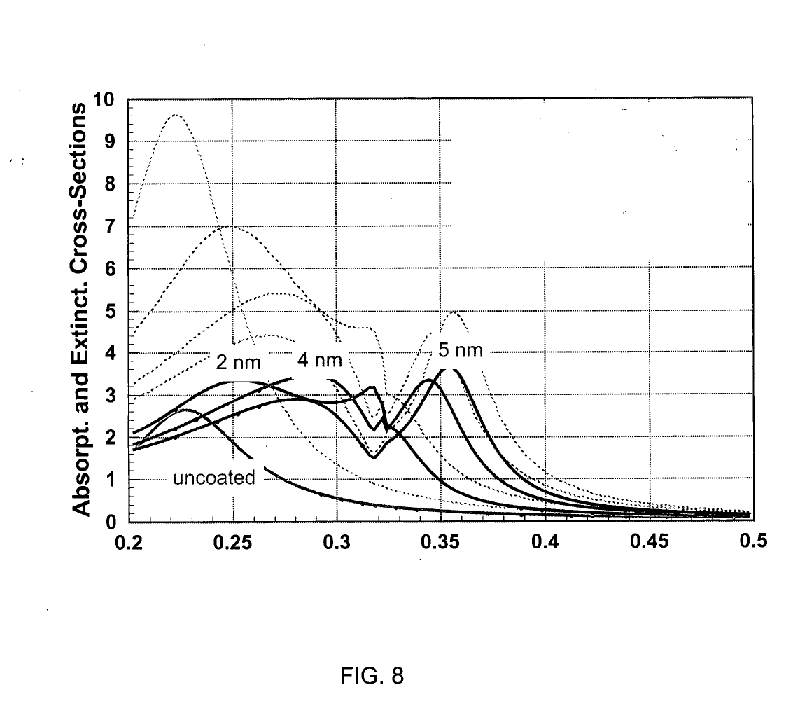

In one embodiment, the core comprises a conducting material and the shell comprises a high refractive index material. This embodiment is illustrated in FIG. 8, which shows absorption (solid line) and extinction (dashed line) cross-sections for aluminum cores, radius 18 nm, coated with a shell of TiO₂ of 2 nm, 4 nm, and 5 nm. As can be seen, the absorption peak may be shifted across the UV spectral band without excessive absorption in the visible range.

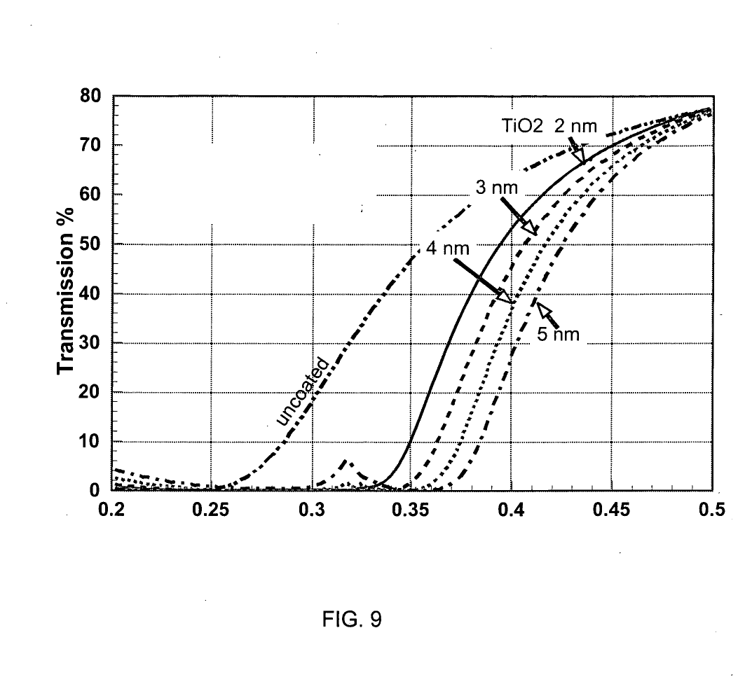

In another embodiment, the particles are dispersed in a carrier at a desired mass loading factor. As illustrated in FIG. 9, the particles, comprising aluminum cores, radius 18 nm, coated with shells of titanium oxide of variable thickness (2 nm, 3 nm, 4 nm, or 5 nm), dispersed in a carrier at a mass loading factor of about 5×10⁻⁶ g/cm², substantially block the transmission of radiation in the ultraviolet range, while remaining transparent in the visible range.

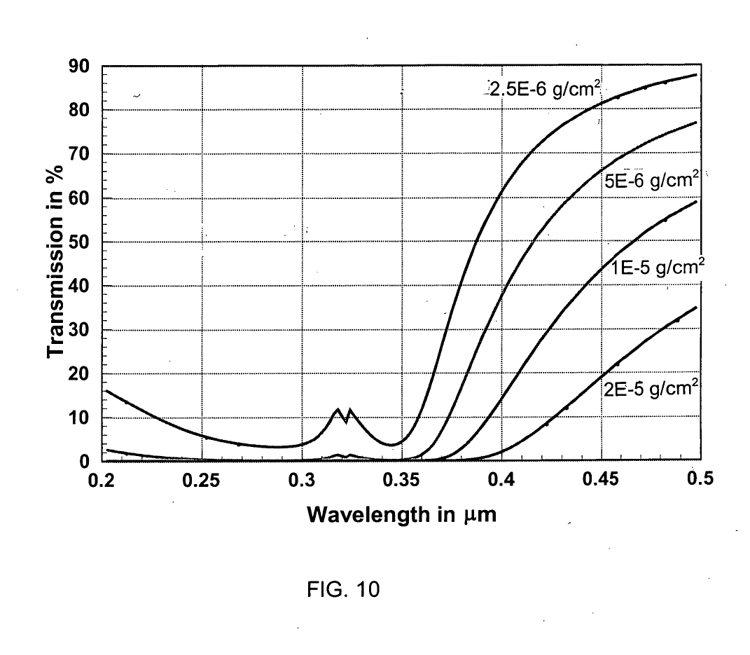

The present invention contemplates a range of mass loading factors that the particles can be dispersed at. FIG. 10 illustrates that the preparation of a carrier and particles of aluminum cores and titanium oxide shells (core radius 18 nm, shell thickness 4 nm) remain absorbent in the UV range at loading factors that vary from 2.0×10⁻⁵ g/cm² to 2.5×10⁻⁶ g/cm².

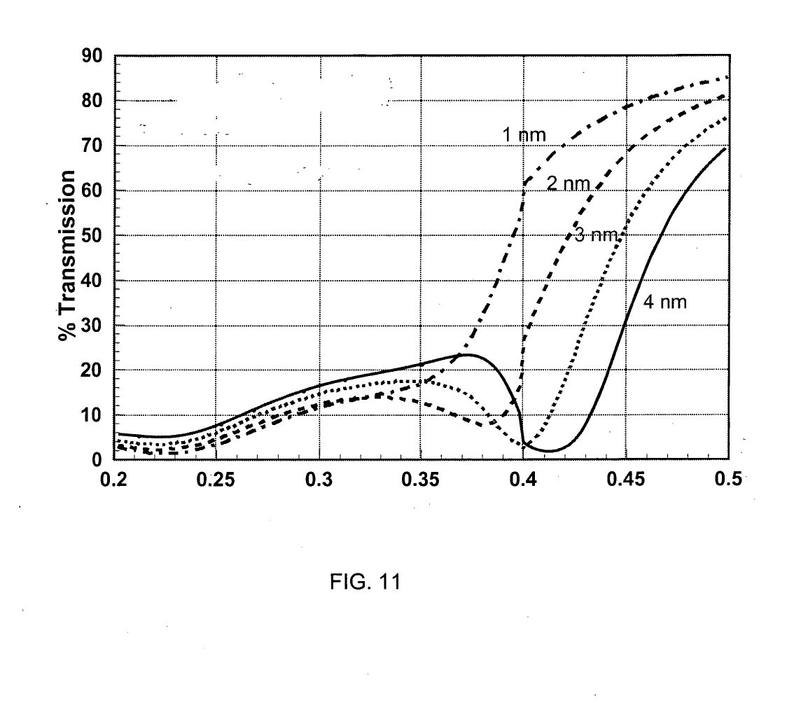

In yet another embodiment, illustrated in FIG. 11, particles of aluminum core, radius 18 nm, coated with a silicon shell of variable thickness (1 nm, 2 nm, 3 nm, or 4 nm) are dispersed in a carrier at the mass loading factor of about 2.5×10⁻⁶ g/cm². Such preparation is substantially absorbent in the UV range, yet substantially transparent in the visible band.

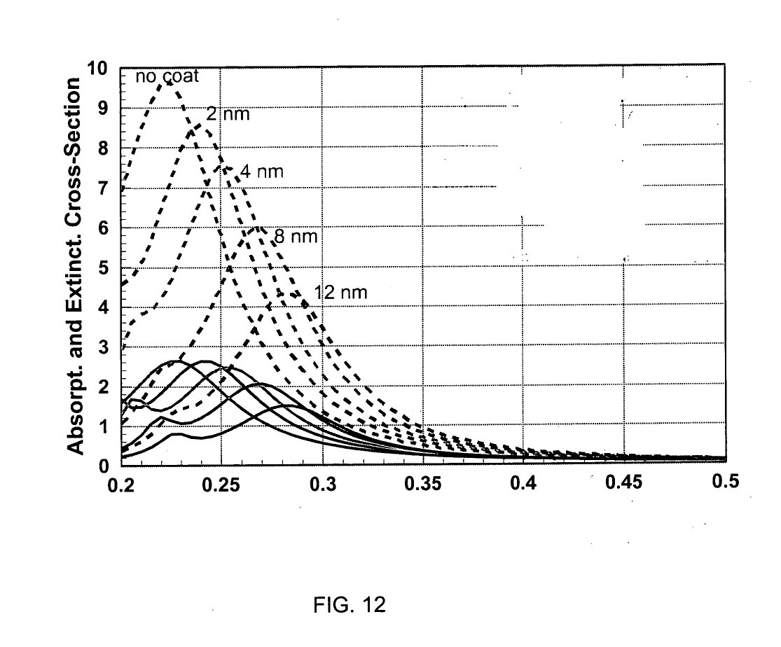

For minimizing visible absorption, the thinner coating of 1 nm to 2 nm are preferred. FIG. 12 shows a particularly simple method of tailoring UV absorption by oxidizing Al nanoparticle core.

Applications

The present invention can be used in a wide range of applications that include blockers, filters, ink, paints, lotions, gels, films, solid materials, and wound dressings that absorb within the ultraviolet spectral band.

It should be noted that resonant nature of the radiation absorption by the particles of the present invention can result in (a) absorption cross-section greater than unity and (b) narrow-band frequency response. These properties result in an “optical size” of a particle being greater than its physical size, which allows reducing the loading factor of the colorant. Small size, in turn, helps to reduce undesirable radiation scattering. Low loading factor has an effect on the economy of use. Narrow-band frequency response allows for superior quality filters and selective blockers. The pigments based on the particles of the present invention do not suffer from UV-induced degradation, are light-fast, non-toxic, resistant to chemicals, stable at high temperature, and are non-carcinogenic.

The particles of the present invention can be used to block radiation in ultraviolet (UV) spectral band, defined herein as the radiation with the wavelengths between about 200 nm and about 400 nm, while substantially transmitting radiation in the visible band (VIS), defined herein as the radiation with the wavelengths between about 400 nm and about 700 nm. As a non-limiting example, particles of the present invention can be dispersed in an otherwise clear carrier such as glass, polyethylene or polypropylene. The resulting radiation-absorbing material will absorb UV radiation while retaining good transparency in the visible region. A container manufactured from such radiation-absorbing material may be used, for example, for storage of UV-sensitive materials, compounds or food products. Alternatively, a film manufactured from a radiation-absorbing material can be used as coating.

Suitable carriers for the particles of the present invention include, among others, polyethylene, polypropylene, polymethylmethacrylate, polystyrene, polyethylene terephthalate (PET) and copolymers thereof as well as various glasses.

A film or a gel, comprising ink or paints described above, are contemplated by the present invention.

The particles of the present invention can be further embedded in beads in order to ensure a minimal distance between the particles. Preferably, beads are embedded individually in transparent spherical plastic or glass beads. Beads, containing individual particles can then be dispersed in a suitable carrier material.

The particles of the present invention can also be used as highly effective UV filters. Conventional filters often suffer from “soft shoulder” spectral absorption, whereby a rather significant proportion of unwanted frequency bands is absorbed along with the desirable band. The particles of the present invention, by virtue of the resonant absorption, provide a superior mechanism for achieving selective absorption. The color filters can be manufactured by dispersing the particles of the present invention in a suitable carrier, such as glass or plastic, or by coating a desired material with film, comprising the particles of the present invention.

The present invention can furthermore be utilized to produce lotions that protect human skin against harmful UV radiation. In this case, the particles are uniformly dispersed within a pharmacologically safe viscous carrier medium, numerous examples of which are readily available and well known in the cosmetics and pharmaceutical arts. For example, as noted above, particles with metallic cores and shells satisfactorily block UV radiation in the UVA, UVB and UVC spectral regions while transmitting light of longer, i.e. visible, wavelengths; such particles also exhibit little scatter when small enough, thereby avoiding an objectionable milky appearance. A gel or a lotion can be manufactured, for example, comprising the particles of the present invention.

The present invention can also be utilized to produce UV radiation-absorbing wound dressing. The particles or a carrier, in which the particles are dispersed, can be incorporated in or deposed as a coating on a textile, textile-like, or a foam matrix, such as gauze, rayon, polyester, polyurethane, polyolefin, cellulose and its derivatives, cotton, orlon, nylon, hydrogel polymeric materials, or any suitable pharmacologically safe material. Such material can be used as a layer in multi-layer wound dressing or as an absorbent layer attached to a self-adherent elastomeric bandage.

Combining particles of different types within the same carrier material is also contemplated by the instant invention.

Cores and shells comprising metals and conducting materials, such as Al, Ag, Mg, TiN, HfN, and ZrN, as well as high-refracting index materials can be used to produce particles absorbing in UV band. Radiation-absorbing properties of the particles can be adjusted by independently selecting the material, radius and thickness of the core and the shell.

Although particles suitable for use in the applications described above can be produced through any number of commercial processes, we have devised a manufacturing method for vapor-phase generation. This method is described in U.S. Pat. No. 5,879,518 and U.S. Provisional Application 60/427,088.

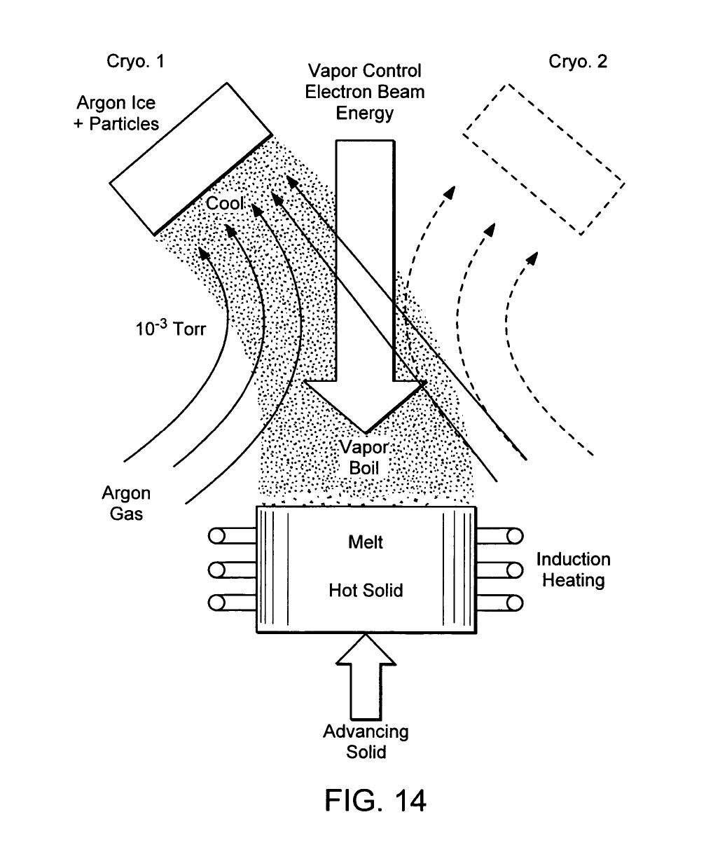

This method, schematically illustrated in FIG. 14, uses a vacuum chamber with heated wall cladding in which materials used to manufacture cores are vaporized as spheres and encapsulated before being frozen cryogenically into a block of ice, where are collected later. The control means for arriving at monodispersed (uniformly sized) particles of precise stoichiometry and exact encapsulation thickness relate to laminar radially expanding flow directions, temperatures, gas velocities, pressures, expansion rates from the source, and percent composition of gas mixtures.

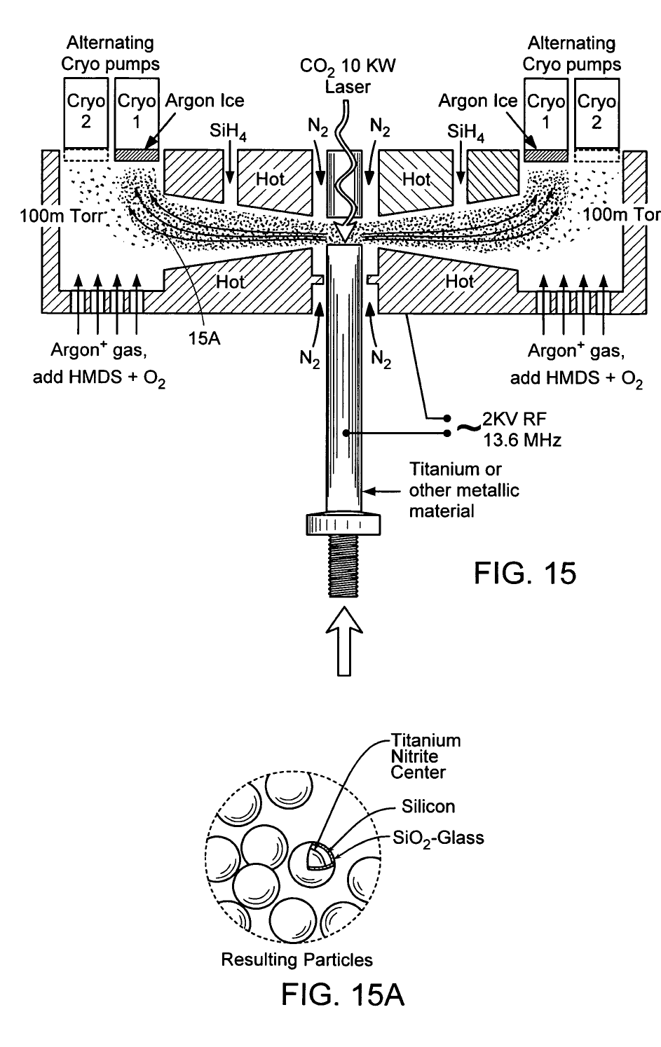

Referring to FIG. 15, in a preferred embodiment, a supply of titanium may be used, as an example. Titanium or other metallic material is evaporated at its face by incident CO₂ laser beam to produce metal vapor droplets. The formation of these droplets can be aided, for narrower size control, by establishing an acoustic surface wave across the molten surface to facilitate the release of the vapor droplets by supplying amplitudinal, incremental mechanical peak energy.

The supply rod is steadily advanced forward as its surface layer is used up to produce vapor droplets. The latter are swept away by the incoming nitrogen gas (N₂) that, at the central evaporation region, becomes ionized via a radio frequency (RF) field (about 2 kV at about 13.6 MHz). The species of atomic nitrogen “N⁺” react with the metal vapor droplets and change them into TiN or other metal nitrides such as ZrN or HfN, depending on the material of the supply rod.

Due to vacuum differential pressure and simultaneous radial gas flow in the conically shaped circular aperture, the particles travel, with minimum collisions, first into a radially expanding conical orifice, and then into an argon upstream to reach several alternating cryogenic pumps which “freeze out” and solidify the gases to form blocks of ice in which the particles are embedded.

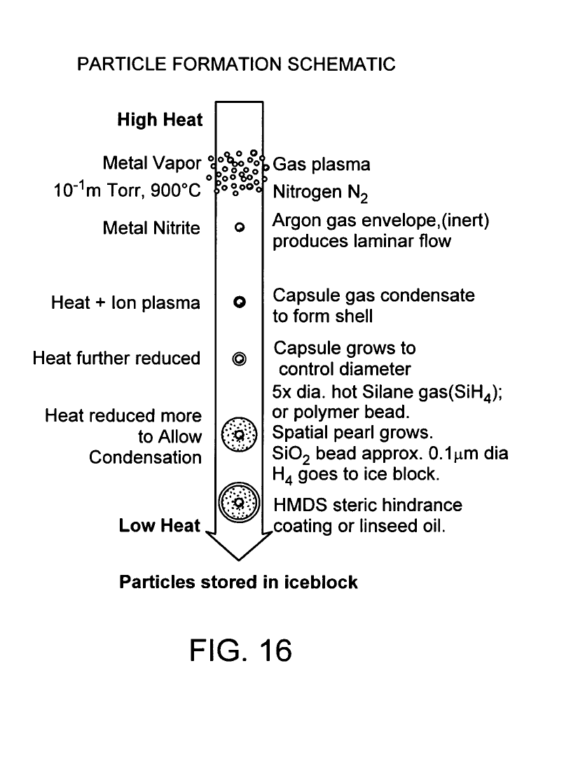

The steps of particle formation are shown in FIG. 16. Here we begin with metal vapor plus atomic nitrogen gas to form metal nitrides. By imparting onto the particles a temporary electric charge, we can keep them apart, and thus prevent collisions, while beginning to grow a thin shell around the nitride core. As non-limiting examples, silicon or TiO₂ can be used, wherein the thickness of the shell is controlled by the rate of supply of silane gas (SiH₄) or a mixture of TiCl₄ and oxygen, respectively.

In a subsequent passage zone, silane gas or a TiCl₄/O₂ mixture are condensed on a still hot nanoparticle to form a SiO₂ or TiO₂ spherical enclosure around each individual particle.

If required, a steric hindrance layer of a surfactant, such as, for example, hexamethyl disiloxane (HMDS), can be deposited on the beads to keep the particles evenly dispersed through a carrier of choice, such as, for example, oil or polymers. Other surfactants can be used in water suspension.

With this manufacturing method, a variety of encapsulated nanoparticles can be produced in large quantities, generating in one single process step the desired resonant-absorption particles and assure their collectability and their uniform size.

While this invention has been particularly shown and described with references to preferred embodiments thereof, it will be understood by those skilled in the art that various changes in form and details may be made therein without departing from the scope of the invention encompassed by the appended claims.

1. An ultraviolet radiation-absorbing particle comprising:
(a) a core; and
(b) a shell,
wherein the shell encapsulates the core; and
wherein either the core or the shell comprises a conductive material,
said material having a negative real part of the dielectric constant in a predetermined spectral band; and
wherein either
(i) the core comprises a first conductive material and the shell comprises a second conductive material different from the first conductive material; or
(ii) either the core or the shell comprises a refracting material with a refraction index greater than about 1.8.

2. The particle of claim 1 wherein said particle exhibits an absorption cross-section greater than 1 in a predetermined spectral band.

3. The particle of claim 1 wherein the particle is substantially spherical.

4. The particle of claim 3 wherein the particle has a diameter from about 1 nm to about 150 nm.

5. The particle of claim 3 wherein the particle has a diameter from about 10 nm to about 50 nm.

6. The particle of claim 1 wherein the shell thickness is from about 1 nm to about 20 nm.

7. The particle of claim 1 wherein either the core or the shell material is selected from a group consisting of Ag, Al, Mg, Cu, Ni, Cr, TiN, ZrN, HfN, Si, TiO2, ZnO₂, Al₂O₃.

8. The particle of claim 1 wherein both the core and the shell comprise conductive materials, and wherein the materials of the core and the shell are selected so that the particle exhibits a peak of absorption in a range of wavelengths from about 200 nm to about 320 nm.

9. The particle of claim 1 wherein both the core and the shell comprise conductive materials, and wherein the materials of the core and the shell are selected so that the particle exhibits a peak of absorption in a range of wavelengths from about 320 nm to about 350 nm.

10. The particle of claim 1 wherein both the core and the shell comprise conductive materials, and wherein the materials of the core and the shell are selected so that the particle exhibits a peak of absorption in a range of wavelengths from about 350 m to about 400 nm.

11. The particle of claim 1 wherein either the core or the shell comprises a refracting material with a refraction index greater than about 1.8, and wherein thickness of the shell and/or the size of the core are independently adjusted so that the particle exhibits a peak of absorption in a range of wavelengths from about 200 nm to about 320 nm.

12. The particle of claim 1 wherein either the core or the shell comprises a refracting material with a refraction index greater than about 1.8, and wherein thickness of the shell and/or the size of the core are independently adjusted so that the particle exhibits a peak of absorption in a range of wavelengths from about 320 nm to about 350 nm.

13. The particle of claim 1 wherein either the core or the shell comprises a refracting material with a refraction index greater than about 1.8, and wherein thickness of the shell and/or the size of the core are independently adjusted so that the particle exhibits a peak of absorption in a range of wavelengths from about 350 nm to about 400 nm.

14. A method of manufacturing a particle that absorbs electromagnetic radiation in the ultraviolet spectral band comprising the step of encapsulating a core with a shell, wherein either the core or the shell comprises a conductive material, said material having a negative real part of the dielectric constant in a predetermined spectral band; and wherein either
(i) the core comprises a first conductive material and the shell comprises a second conductive material different from the first conductive material; or
(ii) either the core or the shell comprises a refracting material with a refraction index greater than about 1.8.

15. The method of claim 14 the core comprises a first conductive material and the shell comprises a second conductive material different from the first conductive material, and wherein the first and the second conducting materials are selected so that the particle exhibits a peak of absorption in a desired spectral band.

16. The method of claim 14 either the core or the shell comprises a refracting material with a refraction index greater than about 1.8, and wherein the thickness of the shell is selected so that the particles exhibits a peak of absorption in a desired spectral band.

17. An electromagnetic radiation-absorptive material for substantially blocking passage of the ultraviolet spectral band of radiation comprising:
(a) a carrier material; and
(b) a particulate material dispersed in the carrier material with a primary particle comprising a core and a shell encapsulating said core, and wherein either the core or the shell comprises a conductive material, said material having a negative real part of the dielectric constant in a predetermined spectral band; and
wherein either
(i) the core comprises a first conductive material and the shell comprises a second conductive material different from the first conductive material; or
(ii) either the core or the shell comprises a refracting material with a refraction index greater than about 1.8.

18. The material of claim 17 wherein the carrier is selected from the group consisting of glass, polyethylene, polypropylene, polymethylmethacrylate, polystyrene, polyethylene terephthalate, and copolymers thereof.

19. The material of claim 17 further comprising one or more distinct particulate materials.

20. The material of claim 17 wherein the material is ink.

21. The material of claim 17 wherein the material is paint.

22. The material of claim 17, wherein the material is lotion.

23. The material of claim 17 wherein the material is gel.

24. The material of claim 17 wherein the material is film.

25. The material of claim 17 wherein the material is solid.

26. The material of claim 17 wherein the material is a textile.

27. The material of claim 17 wherein the material is a textile, textile-like, or a foam matrix selected from a group consisting of gauze, rayon, polyester, polyurethane, polyolefin, cellulose and its derivatives, cotton, orlon, nylon, and hydrogel polymeric materials.

28. The material of claim 27 wherein the material is attached to a self-adhering elastomeric bandage.

29. The material of claim 17 wherein the primary particles are further embedded in beads.

30. The material of claim 29 wherein the primary particles are individually embedded in substantially spherical beads.
